(19) United States
(12) Patent Application Publication
(10) Pub. No.: US 2007/0012631 A1
(43) Pub. Date: Jan. 18, 2007

(54) Methods for controlling pH in water sanitized by chemical or electrolytic chlorination

(76) Inventors: Richard T. Coffey, Pompano Beach, FL (US); Micheal Haven, Cincinnati, OH (US); Robert Harnden, Tamarac, FL (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/182,110

(22) Filed: Jul. 15, 2005

(51) Int. Cl. C02F 1/00

(52) U.S. Cl. 210/743

(57) ABSTRACT

The invention relates to the control of pH in water where hydroxyl ions are being produced by adding to the water an amount of transition metal salt sufficient to bind with hydroxyl into a slightly soluble or insoluble reaction product, thereby removing sufficient hydroxyl ion from the water to lower the pH thereof. This technique is particularly suitable for pH control in pool or spa water that is sanitized using chemical or electrolytic chlorination, where the sanitation process causes the pH in the water to rise.

### BACKGROUND OF THE INVENTION

1. Field of the Invention

The invention relates to methods for controlling pH in electrolytic or “salt water” chlorinators by the addition of transition metal salts, particularly transition metal halides, such as zinc (II) halides. The technique of the invention permits pH control without the need to add potentially dangerous protic acids to the water.

2. Description of Related Art

Purification of water, in particular of pool and spa water, is typically carried out by one or more of several different methods. Chemical methods typically involve adding chemical microbiocides, such as hypochlorite ion, silver ion, copper ion, and the like, to the water. The addition is either direct, as in most hypochlorite additions, or indirect, as in the addition of silver ion from an immobilized media, such as NATURE2®, available from Zodiac Pool Care.

However, electrochemical methods may be used in place of, or in addition to, chemical methods, as described in U.S. Pat. No. 6,761,827, the entire contents of which are incorporated herein by reference. In these methods, water having some concentration of halide ion in it (achieved by dissolution of quantities of sodium chloride, sodium bromide, or other halide salts into the water) is passed through an electrolytic cell. The halide ions are oxidized by electrolysis to form hypohalous acid, hypohalite ions, or both (believed to occur through the intermediate of molecular halogen), which have known utility in disinfecting water (and whose use is typically known as “chlorinating,” brominating, or otherwise halogenating the water). In addition, the electrolysis reaction converts water into hydrogen and oxygen.

Electrolytic purification is desirable because it is safe, effective, and for applications such as swimming pools, hot tubs, spas, etc., it eliminates much of the need for the pool owner or operator to handle chemicals and monitor water chemistry. The salinity levels necessary to achieve effective chlorination levels are typically well below the organoleptic thresholds in humans, and the primary chemical required to be handled by the operator is a simple alkali metal halide salt. In addition, operation of the electrolytic cell is comparatively easy, and requires little attention beyond ensuring the proper current and voltage levels are set, and maintaining the correct salinity levels in the water.

A disadvantage associated with the use of electrolytic purification is an upward creep in pH (although this phenomenon also occurs with other means of addition of hypochlorite, such as trichloroisocyanurates, trichloroisocyanuric acids, and the less halogenated cyanuric species). Electrolytic generation of chlorine-type disinfectants from chloride ions at the anode of the electrolysis cell also generates hydrogen and oxygen at the cathode of the electrolysis cell, consuming hydrogen ion and leaving hydroxyl ion, a strong base. The hydroxide ion cogenerated in the vicinity of the cathode can then distribute throughout the pool or spa water, gradually increasing the pH of the pool or spa water over time.

The pool owner or technician, in servicing the pool, must monitor this pH rise, and at a certain point, chemically treat the pool to bring the pool water back to an acceptable pH range, in order to maintain optimal efficiency of disinfection, algal control, water clarity, etc. Various techniques exist to accomplish this, the simplest being to simply add a quantity of mineral acid, e.g., HCl, to the pool water. While simple in theory, acid addition involves storage and handling of a potentially hazardous chemical in significant quantities, requires careful handling, mixing, and monitoring to avoid lowering the pH too much, and presents dangers of spills, splashes, burns, poisoning, and the like.

In addition, to be safe and effective, the added mineral acid must be dispersed throughout the pool thoroughly and quickly. Simply dumping large quantities of concentrated acid into the pool will likely create a localized region where the acid concentration is rather high, at least in the short term, until the acid is dispersed by diffusion and mixing of water by the filtration system. During this time, the pool is essentially unusable. The acid could be added in diluted form, which would speed mixing and increase safety, and indeed, this is done by many pool owners by adding muriatic acid to the pool. However, this technique is time consuming for the pool owner or technician, and requires skill, care, and attention during the mixing process to avoid spillage and burns, ensure that the correct amount of acid is added, etc., and also requires handling much larger volumes of material. Metering acid into the pool through the water circulation system used to filter the pool water would eliminate some of these problems, but is disadvantageous in that it can lead to corrosion of piping, pumps, and other flow control elements.

Because of the disadvantages described above, it would be desirable to have a method for controlling pH in chemically and electrolytically sanitized pools that eliminates the need for addition of strong protic acids to the pool water.

Possible alternative methods for lowering pH with reduced handling and monitoring by pool owners or maintainers include automated introduction of hydrochloric acid (U.S. Pat. No. 5,362,368), addition of controlled amounts of acid and reaction in a fixed bed of base reactant (e.g. calcium carbonate) (DE 20011034 U1; CAN 133:366155), automated shut-off of the electrolytic chlorinator when hydroxide levels reach a preset amount (U.S. Pat. No. 5,567,283 and WO 9925455) or during certain time periods (BR 8804112; CAN 110:198879). Another approach involves discharging from the system any excess basic water from the vicinity of the cathode (U.S. Pat. No. 3,669,857).

None of these methods provides a particularly acceptable solution to the problem. Automated introduction of hydrochloric acid still requires some handling of a potentially dangerous chemical. Techniques involving automated shut-off of the electrolytic cell also result in shut off of chlorination when the cell is not in operation. Accordingly, there remains a need in the art for a method for control of pH increase in electrolytic and other chlorinators (including direct chemical addition of hypochlorite) that does not require the use or handling of strong acids, that is easily and safely implemented by pool owners and maintainers, and that is effective in reducing pH and maintaining it at desirable levels. Techniques requiring discharge of basic catholyte to waste require some mechanism for disposing of the caustic waste, adding complexity to the pool maintenance regimen.

Attempts appear to have been made to reduce pH by addition of an aqueous HCl solution containing 5 to 200 g dissolved Zn per liter through a metering pump in Schneider, CH 589008 (CAN 87:141081). This technique is claimed to maintain the pH of pool water relatively constant over a period of 3 months. The inclusion of zinc appears to be related to control of turbidity due to hydrated iron oxide; i.e., the zinc appears to be added as a clarifying agent, rather than to have any role in pH reduction, which is accomplished by the hydrochloric acid.

Techniques that do not require acid addition or control of chlorinator operation include adding CO₂ from gas cylinders into the pool or purification line (DE 2,255734; CAN 81:96311), and addition of granular MgO (optionally combined with CaO and/or Na₂O) as a pH control agent in a pool water system purified with sodium trichloroisocyanurate [sic], disclosed in JP Kokai Tokkyo Koho 08189217 (CAN 125:256656).

### SUMMARY OF THE INVENTION

Applicants' invention solves the problems associated with prior methods of pH control by the introduction of soluble transition metal salts into the pool water. The transition metal salts contemplated are those capable of measurably affecting the pH of the water when added thereto. More particularly, the transition metal halides are those capable of measurably reducing the pH of the water when added thereto, eliminating or substantially reducing the need to add mineral acids to the water to control pH. Even more particularly, the transition metal salts contemplated are those capable of reacting with hydroxide ions to form a stable compound. Desirably, this stable compound is one that can be effectively removed from the pool water, but this is not necessary for the practice of the invention. Thus, the invention relates to the use of transition metal salts to control pH in water having a source of hydroxide ions.

In a particular embodiment, Applicants' invention relates to the use of transition metals salts such as transition metal halides, transition metal borates, transition metal sulfates, and the like, that are relatively soluble in water, and that form transition metal hydroxides that are considerably less soluble in the water than the added transition metal salts. Particularly suitable transition metal salts include zinc halides, particularly zinc chloride, which, according to this invention, are used to control the pH rise in water that accompanies chemical or electrolytic sanitation by introduction or production of hypochlorites. The methods of the invention provide a technique for slowing, and in some cases, reversing, the rise in pH that occurs in such sanitation systems, without the need to use or handle potentially hazardous chemical species, including strong acids, such as hydrochloric acid or sulfuric acid. Zinc chloride, in particular, is safe, easy to handle, readily dissolves in water, and forms a reaction product with hydroxyl ion that is only very slightly soluble in water, enabling it to be removed from the water by filtration or other means, if desired.

More specifically, the invention relates to a method for controlling pH in water, comprising:

adding to a stream or body of water a transition metal salt in sufficient quantity to measurably affect the pH of the water.

In another embodiment, the invention relates to the pH controlling composition added to the water, and in particular, relates to a pH controlling composition, comprising:

a pH controlling amount of a transition metal halide;

sufficient water to form an aqueous solution thereof. This composition desirably does not contain any hydrochloric acid, sulfuric acid, or other strong protic mineral acid in sufficient amounts to measurably affect the pH of the water to which the composition is added.

### BRIEF DESCRIPTION OF DRAWINGS

FIG. 1 is a graph showing the effect on pH of the addition of zinc (II) chloride to water purified by an electrolytic chlorinator in a 6 L vessel.

FIG. 2 is a schematic diagram of one embodiment of an apparatus used to carry out the method of the invention.

FIG. 3 is a graph showing the effect on pH of the addition of zinc (II) chloride to water purified by an electrolytic chlorinator in a simulated pool.

### DETAILED DESCRIPTION OF SPECIFIC EMBODIMENTS

As described above, transition metal salts, such as transition metal halides, borates, and sulfates can be used to control pH increases in pool or spa water that accompany sanitation of the water by “chlorination.” In particular, increases in pool water pH that accompany the operation of electrolytic chlorinators can be reduced and controlled by the addition of these transition metal halides. Particularly good results have been found with zinc halides, in particular, zinc chloride (ZnCl₂), but while the description herein focuses on this compound, it will be understood that the other transition metal halides described herein can be used in substantially the same way to control pH in water. In addition to providing good pH control, zinc chloride is safe and easy to handle, measure, and add to pool water. Zinc chloride is highly water soluble, making its dispersal in pool water rapid and easy for the pool owner.

Without wishing to be bound by any theory, it is believed that the transition metal salts used in this invention form a reaction product with hydroxyl ion (e.g., zinc hydroxide) that is very slightly soluble in water, pulling hydroxyl ion out of the water where it would raise pH. In addition, because the hydroxide product is relatively insoluble, it can be removed from the pool water if necessary to, for example, drive the reaction:
ZnCl₂+2OH⁻ [symbol] Zn(OH)₂+2Cl⁻
to the right.

In the discussion that follows, the term “pool” or “pool water” is intended not to be strictly limited to swimming pools, but to apply to any body of water whose pH must be controlled in response to a pH increase due to sanitation with a hypohalite. It is specifically intended to include water contained in spas, hot tubs, Jacuzzis, cooling towers, water purification installations, and the like.

The transition metal halide, e.g., zinc chloride, can be added to the pool water by any convenient technique. It has been found that continuous addition of fairly dilute aqueous solutions of zinc chloride provides better control of the pH time response than batch addition, although both are effective at controlling and slowing the rise in pH. Continuous addition of aqueous zinc chloride solution via a reservoir and pump arrangement provides continuous control; at appropriate concentrations of ZnCl₂, this method of addition can not only limit the increase in pH with time, but can actually reverse it, driving it back toward the pH level when operation of the chlorinator began. However, because zinc chloride is actually a Lewis acid, care should be taken that the amount added should not be so high as to drive the pH level below the starting point, unless that is what is desired.

In general, the amounts of transition metal halide added to the water may be substantially variable, depending upon water conditions, chlorination levels, and method of addition. For bulk addition, amounts of solid zinc chloride ranging from about 10 mg to about 30 mg per gallon of water can be used. Addition will need to be repeated every 1-2 days or so, or when pH begins to rise again, depending upon chlorinator operation, pool chemistry, weather conditions, and the like. Continuous addition can be of solid zinc chloride, but use of an aqueous solution is more practical, as solid zinc chloride will absorb moisture from the surrounding air quite quickly. Aqueous solutions of concentrations ranging from about 0.1 mM to about 1 M, more particularly, between about 10 mM and about 1 M can be advantageously used. Addition rates can be chosen so that about 2.4 mg ZnCl₂/gal/hr is delivered to the water, in order to provide sufficient pH control for most conventional electrolytic chlorinators, which typically deliver 1 mg Cl₂/gal/hr without causing cloudiness or imparting an off-white color to the water. The volume of ZnCl₂ solution needed per gallon of water per hour ranges from 1.8 ml for a 10 mM ZnCl₂ solution to 0.6 ml for a 30 mM ZnCl₂ solution. These molar concentrations of zinc chloride solution are suitable for the smaller volumes found in a spa or hot tub. For a full sized swimming pool, a more concentrated ZnCl₂ may be appropriate. For a 1 M solution, the addition rate would be about 0.18 L/hr, or about 1.4 L per 8 hour day. The use of a more concentrated solution reduces the volume of liquid that must be handled by the pool owner or technician, making use of the technique more practical. One of skill in the art can easily scale the addition rate based on these ranges and concentrations to a level suitable for any sized pool. If an electrolytic chlorinator is operated so as to release substantially more hydroxyl ions to the pool water (e.g., because the flow rate of chloride ion through the chlorinator is increased, or the chlorinator voltage is increased, or both), then a higher level of solution addition rate, or a more concentrated solution, may be required to maintain proper pH control.

The zinc chloride, whether added as a batch or continuously, is added in the absence of hydrochloric acid, sulfuric acid, and/or other mineral acids. Moreover, pH control methods within the scope of the invention that include the addition of zinc chloride for pH control can be practiced without the addition of these acids to the pool water. In addition to avoiding the need to handle potentially hazardous chemicals conventionally used to control pH the system according to the invention lends itself to automated addition. For example, it is contemplated to be within the scope of the invention to add zinc chloride by controlled dispensing of an aqueous solution thereof by a pumping mechanism, such as a diaphragm or peristaltic pump, or by another dispensing mechanism, e.g., a venturi inlet.

This controlled dispensing mechanism can be connected electronically to a pH meter and a feedback controller so as to continuously control zinc chloride addition in response to changes in water pH. As the pH in the pool changes past a set point, a pH meter senses this change and signals a controller to add more zinc chloride to the water when the deviation from the set point reaches a certain differential. When pH returns to the set point (i.e., within the differential from the set point) as measured by the pH meter, the controller discontinues zinc chloride addition.

Other transition metal halides that can be used in the invention include those capable of reacting with hydroxyl ion to form an insoluble or slightly soluble product. These include aluminum chloride (in particular, aluminum chloride hexahydrate), zinc bromide, zinc iodide, copper chloride (in particular copper chloride dihydrate), nickel chloride (in particular, nickel chloride hexahydrate), nickel bromide, nickel iodide, and tin halides, such as stannous chloride (anhydrous and dihydrate), stannous bromide, and stannous fluoride.

### EXAMPLES

A DuoClear™ 15 electrolytic chlorinator sold by Zodiac Pool Care was suspended in a vessel containing 6 L of water and operated on an intermittent cycle on its lowest setting during the testing described below. The vessel was arranged so that zinc chloride could be added by either batch addition or through a peristaltic pump, and which was monitored for pH over time. The vessel was stirred with a magnetic stirrer. None of the examples involved the addition of hydrochloric acid or other mineral acids to the water, and temperature and other operating conditions were consistent from run to run. In the Comparative Examples below, conditions were the same as for the Examples, but zinc chloride was not added.

### Comparative Example 1

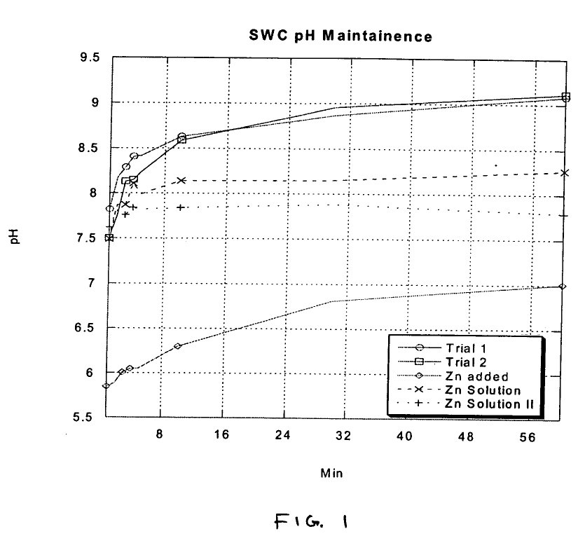

The operating conditions for Example 1 were followed except that no zinc chloride was added. Under two different trials, pH of the water increased from a beginning pH of 7.5 or 7.75 to a pH of approximately 9.1 after running the electrolytic chlorinator for only 60 minutes. This is represented graphically in FIG. 1 by the curves labeled “Trial 1” and “Trial 2.”

### Example 1

The apparatus was operated as decribed above. Prior to operation and zinc addition, the water was conditioned to simulate pool water by adding 1.2 g CaCl₂ (to simulate water hardness) and 0.8 g NaHCO3 (to simulate water alkalinity), followed by addition of 10 g NaCl to provide the desired salinity for the electrolytic chlorinator. 6.28 g of zinc chloride was added by one-time batch addition and mixed overnight. Because the zinc chloride is a Lewis acid, this addition and mixing reduced the initial pH from 7.9 to 6.0. The resulting increase in pH was limited to approximately 1.25 pH units over 60 minutes, from an initial pH of around 5.75 to a final pH of around 7 (as indicated in FIG. 1 by the curve labeled “Zn added”). This is approximately half of the pH increase occurring in the control experiments.

### Example 2

The procedure described in Example 1 was followed, except that following water conditioning, zinc chloride was added as a 12.2 mM aqueous solution via a peristaltic pump at a rate of 10.5 ml/min. The pH time response of the system to this addition is shown by the curve in FIG. 1 labeled “Zn Solution.” The pH of the system shows a net increase of only about 0.8 pH units over 60 minutes of operation. Perhaps more significantly, after about 10 minutes of operation, the pH time response curve is essentially flat, with only a slight upward trend occurring at about 60 minutes. This is in contrast to both the control and the batch addition curves which, while seeming to increase more slowly after 60 minutes, still show a more decided upward trend.

### Example 3

The procedure described in Example 2 was followed, except that the zinc chloride was added as a 25 mM solution at a rate of 10.2 ml/min. The pH time response is given by the curve labeled “Zn Solution II” in FIG. 1. Over the course of 60 minutes of operation, the pH increase was only about 0.2 pH units. Moreover, after about 30 minutes of operation, the pH time response curve was trending downward, indicating that the zinc chloride addition was not only preventing further pH increase, but was actually beginning to reverse the increase and return pH toward the pH level when the chlorinator operation began.

### Example 4

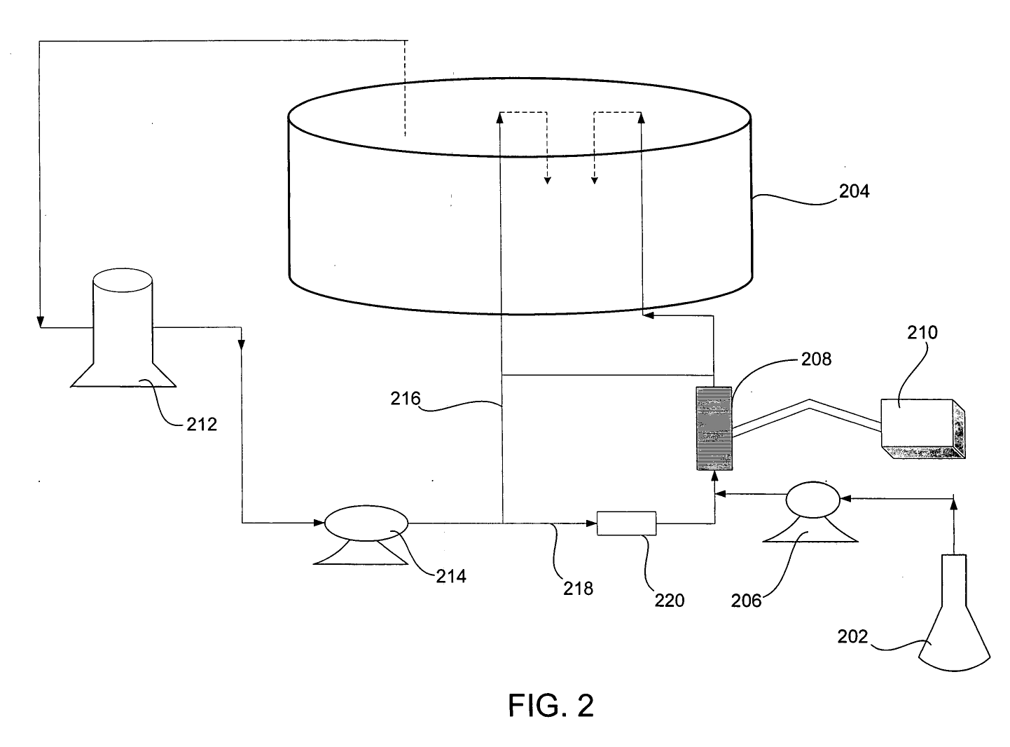

The electrolytic-chlorination and ZnCl₂ addition procedure was scaled up to a 200 gallon “mini-pool” using the apparatus having a filter, recirculation pump, ZnCl₂ metering pump and flask containing the ZnCl2 solution, chlorine cell and controller, and plumbing system, all in fluid communication with the pool as shown schematically in FIG. 2, which could also be applied to a full sized pool with appropriate changes in equipment. In this system, zinc chloride is supplied as a 25 mM aqueous from reservoir 202 to the mini-pool 204. The solution is forced by peristaltic pump 206 through electrolytic chlorinator 208 (which is controlled by controller 210. Water in mini-pool 204 is recirculated through filter 212 by centrifugal pump (2 hp) 214. A portion (or all) of the recirculated water may be returned to mini-pool 204 by bypass line 216, while another portion is conducted by line 218 through flow meter 220 to electrolytic chlorinator 208. Those of skill in the art will recognize that the same or similar arrangement of apparatus could be used to purify water and control pH in much larger pools, optionally using larger capacity equipment.

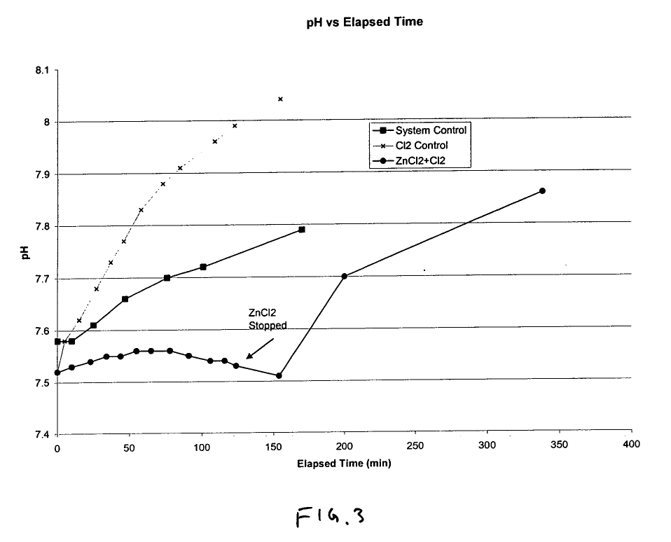

Three experiments were conducted, monitoring pH, temperature, and free available chlorine. All were conducted in simulated pool water, balanced with respect to pH, total alkalinity, hardness and cyanuric acid chlorine stabilizer. Pumping flowrate was roughly 80 gpm. The first experiment was a “system control”, monitoring pH and temperature without chlorination or addition of ZnCl₂. The second experiment was a “Cl₂ control”, where only chlorine was added at a rate of 2 g/hr. The third experiment (“ZnCl₂+Cl₂”) involved chlorination at the same rate as experiment 2 plus the continuous, in-line metered addition of a 25 mM solution of ZnCl₂ at a rate of 1.2 liters/hr, which was a 5% stoichiometric excess. The temperature-corrected pH was monitored in-line with readings taken at regular intervals. The water temperature increase of 4.5° C. was consistent for all three experiments. FIG. 3 graphically depicts the pH curves of all three experiments. The system control pH increased by 0.2 pH units over a period of 170 minutes, which is believed to be the result of CO₂ loss from the water. A 0.5 pH unit increase was experienced in the Chlorine control experiment over a period of 155 min. Finally, the ZnCl₂ metering experiment resulted in no pH increase over the course of 125 minutes during which the ZnCl₂ metering pump was operating. After 125 minutes of elapsed time, the ZnCl₂ pump was turned off while the pH continued to be monitored. As seen in the figure, the pH dropped 0.02 units followed by an increase of 0.35 units over a 200 minute period as the excess ZnCl₂ was consumed and an excess of hydroxyl ion was generated by the chlorinator.

The Examples described above show that transition metal halides, such as zinc chloride, can be effectively used to control the increase in pH resulting from the use of chlorination, in particular electrolytic chlorination, to sanitize pools. This use does not require the handling of dangerous protic acids, does not cause corrosion of ancillary pipes or other equipment, lends itself to automation, and requires little care and maintenance.

What is claimed is:

1. A method for controlling pH in water, comprising:
adding to a stream or body of water a transition metal salt in sufficient quantity to measurably affect the pH of the water.

2. The method of claim 1, wherein the transition metal salt is capable of reaction with hydroxide ion under ambient water conditions to form a stable reaction product, thereby removing hydroxide ion from the water in sufficient quantities to measurably affect the pH of the water.

3. The method of claim 1, wherein the transition metal salt is a transition metal halide, borate, or sulfate.

4. The method of claim 1, wherein the transition metal is zinc (II).

5. The method of claim 4, wherein the transition metal salt is a zinc (II) halide.

6. The method of claim 5, wherein the transition metal halide is zinc (II) chloride.

7. The method of claim 1, wherein the transition metal salt is added as a batch addition.

8. The method of claim 1, wherein the transition metal salt is added in a continuous fashion.

9. The method of claim 8, wherein the transition metal salt comprises an aqueous solution of zinc (II) chloride.

10. The method of claim 9, wherein the aqueous solution has a concentration of between about 0.1 mM and about 1 M.

11. The method of claim 10, wherein the aqueous solution has a concentration of between about 10 mM and about 1 M.

12. The method of claim 11, wherein the aqueous solution has a concentration of between about 12 mM and about 25 M.

13. The method of claim 1, wherein the transition metal salt is added in the absence of pH modifying amounts of hydrochloric acid.

14. The method of claim 13, wherein the transition metal salt is added in the absence of pH modifying amounts of any mineral acid.

15. The method of claim 1, further comprising:
sensing the pH of the water;
comparing the sensed pH to a set point, thereby generating a pH differential;
introducing an amount of transition metal salt to the water when the pH differential reaches a predetermined value;
wherein the amount of transition metal halide introduced is sufficient to reduce the pH differential.

16. A pH controlling composition, comprising:
a pH controlling amount of a transition metal salt;
sufficient water to form an aqueous solution thereof.

17. The pH controlling composition of claim 16, wherein the transition metal salt comprises a transition metal halide, borate, or sulfate.

18. The pH controlling composition of claim 17, wherein the transition metal salt comprises a transition metal halide.

19. The pH controlling composition of claim 18, wherein the transition metal halide comprises a zinc (II) halide.

20. The pH controlling composition of claim 19, wherein the zinc (II) halide comprises ZnCl₂.

21. The pH controlling composition of claim 18, wherein the transition metal halide is present in a concentration ranging between about 0.1 mM and about 1 M.

22. The pH controlling composition of claim 21, wherein the transition metal halide is present in a concentration ranging between about 10 mM and about 1 M.

23. The pH controlling composition of claim 21, wherein the transition metal halide is present in a concentration ranging between about 12 mM and about 25 mM.

24. The pH controlling composition of claim 18, wherein the composition is free of quantities of mineral acids sufficient to measurably affect the pH of the water to which the composition will be added.
